(19) United States
(12) Patent Application Publication
(10) Pub. No.: US 2002/0065949 A1
(43) Pub. Date: May 30, 2002

(54) Virtual network computing

(76) Inventor: Dennis Heaton, Ann Arbor, MI (US)

Correspondence Address: Steven L. Oberholtzer, BRINKS HOFER GILSON & LIONE, P.O. Box 10395, Chicago, IL, 60610, US

(21) Appl. No.: 09/881,577

(22) Filed: Jun. 14, 2001

Related U.S. Application Data
(60) Provisional application No. 60/211,383, filed on Jun. 14, 2000.

(51) Int. Cl. G06F 9/46

(52) U.S. Cl. 709/318

(57) ABSTRACT

A monitoring system particularly suited for remote viewing of display or events on computers over a distributed computer network such as the Internet. In such a distributed network, a person located at a remote viewing station can watch all display or event activity occurring on the computer or server to be monitored. The display on the remote systems is almost instantaneous except for communication delays. Either the viewer or the server can start the initiation of the remote monitoring by sending a handshaking communication. Once communication is established, the remote viewer may watch either the entire display of the server or a selected window that is being displayed.

### BACKGROUND OF THE INVENTION

This invention relates generally to distributed computer systems that allow remote monitoring of events occurring on another computer.

The time is fast approaching where most computers are interconnected together in some type of network whether it is a local area network, wide area network or the Internet. Often a person may want to display the information, screen or data of a computer that is located in another area n real time. The other computer may be located in another room, in another building or across the country.

Applications that may be remotely monitored, but not limited to, include medical instrumentation, maintenance, technical support, and education.

It is clear from the foregoing that there is a need for a real time methodology and system to enable remote computer monitoring of display and events occurring on another computer over distributed computer networks.

### SUMMARY OF THE INVENTION

The present invention contemplates a system that allows a computer to be located remote from another computer that is the source of the display or events and provide real time remote monitor of that display or events over a distributed computer network.

Although the present invention is described relative to the Internet, its application is not so limited and is intended to be used on any distributed computer system in which a person interacts with another computer for the purposes of remotely monitoring events on the other computer.

In such a distributed computer network, a computer may contain a software application displaying information on a screen and a person in a remote location desires to view the same displayed information on their local computer screen in real time. This information is intended to give the remotely located person the ability to perform their job as if they were located at the source computer.

These subsystems, and other subsystems expressed or implied in this document, are accomplished in one embodiment by a system for connecting, over a distributed computer network, a remotely located computer to another computer containing source data and displaying that source data on the remote computer, the system comprising: (a) an executing software program retrieving the source display data on the server, (b) a distributed computer network for transmitting the display data, (c) an executing software program on the remote computer for receiving the transmitted display data and displaying the same data on the computer monitor.

### DRAWINGS IN BRIEF

FIGS. 1A and 1B are block diagrams of the two computer configurations used in the preferred embodiment.

FIG. 1C is a graphical representation of the preferred memory organization for the computer illustrated in FIG. 1A.

FIG. 1D graphically illustrate the connection between the two computers.

FIG. 1E is a flowchart of the preferred embodiment's remote monitoring system.

FIG. 1F is a flowchart of the preferred embodiment messaging subsystem.

### DRAWINGS IN DETAIL

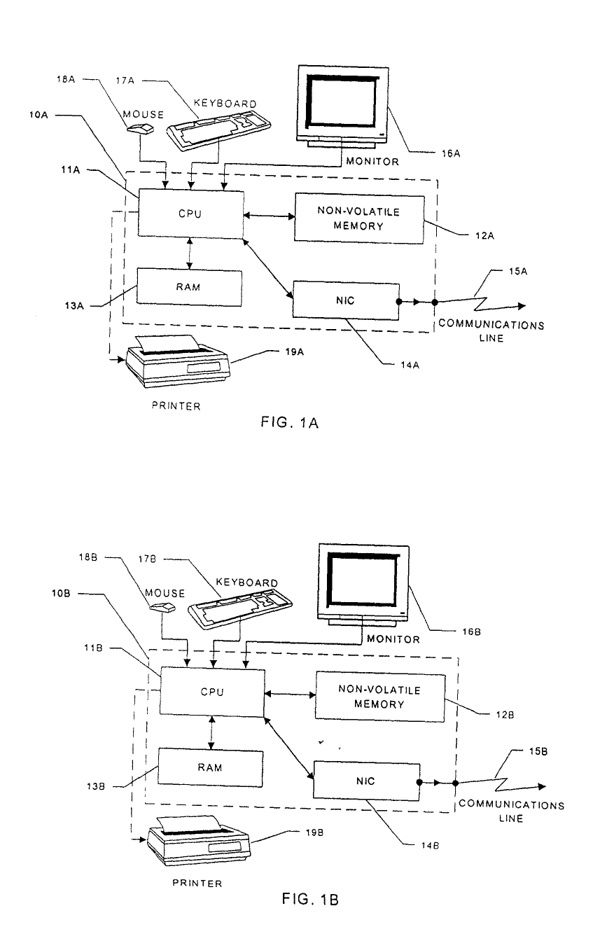

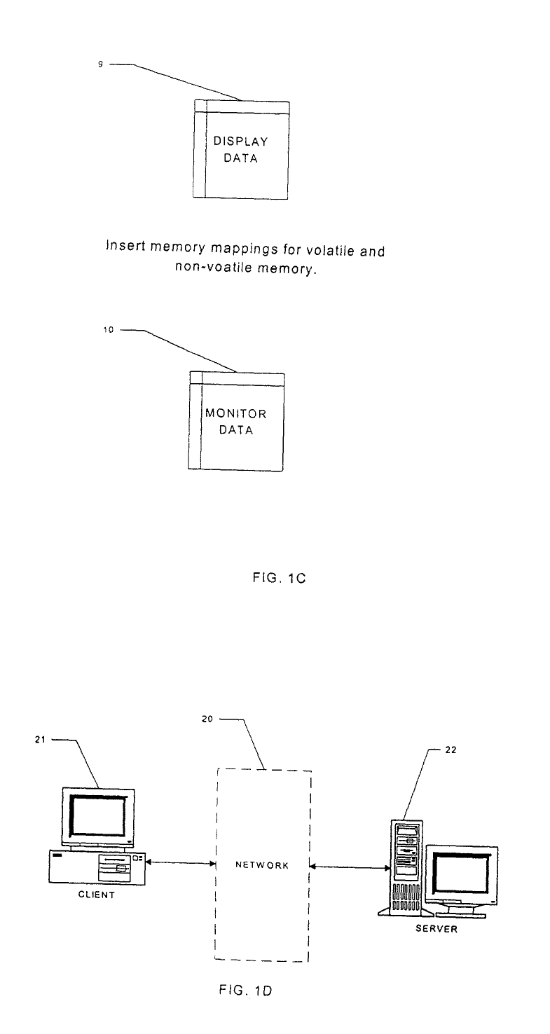

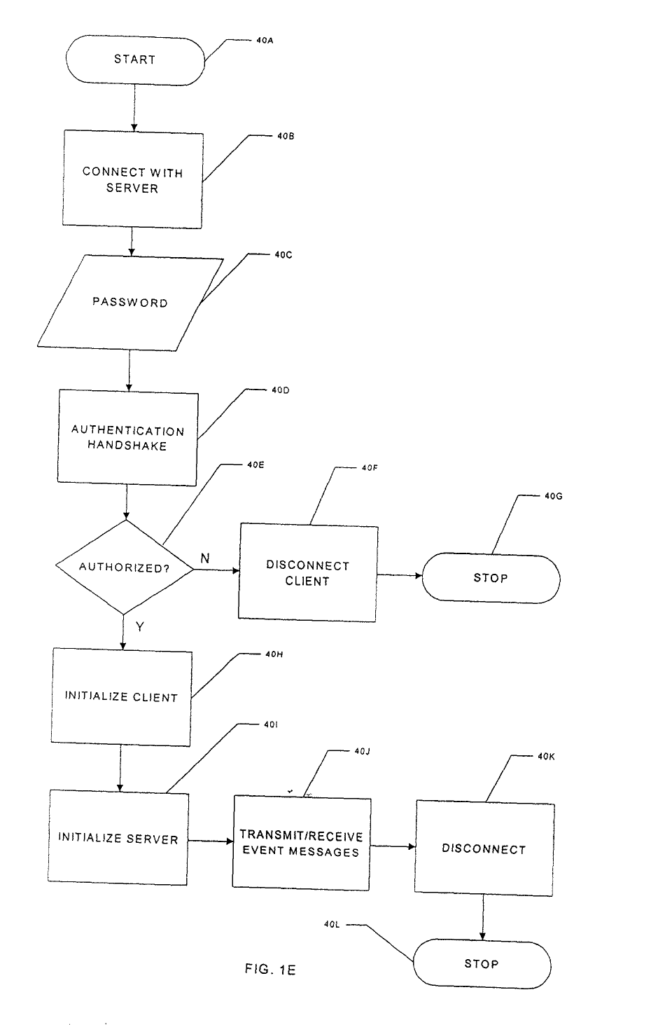

FIGS. 1A and 1B are block diagrams of the two computer configurations used in the preferred embodiment.

FIG. 1A illustrates the configuration of the computer or server containing the source display and events that are going to be monitored. As shown, computer 10A is a simple layout of a Central Processing Unit (CPU) 11A which uses both non-volatile memory 12A and Random Access Memory (RAM) 13A. RAM 13A contains the currently displayed data on Monitor 16A that a operator uses to view the display data.

Communications to and from CPU 11A is via Network Interface Card 14A, which can be a modem, attached to a phone line or a card, directly connected to a network that communicates with other computers via Communications Line 15B.

Computer 10B, illustrated in FIG. 1B, shows the preferred computer configuration for the computer or client that is remotely communicating to the server 10A and displaying the source data originating from computer 10A. As shown, computer 10B is a simple layout of a Central Processing Unit (CPU) 11B which uses both non-volatile memory 12B and Random Access Memory (RAM) 13B. In the case of the remote client computer, RAM 13B contains the real time display data of RAM 13A of Computer 11A communicated via CPU 11B through NIC 14B and Communications Line 15B.

The system is able to communicate with an operator at Computer 10B using Monitor 16B that is displaying via the real time display data of RAM 13B and thus RAM 13A can be viewed on Monitor 16B.

Keyboard 17A is used to communicate operator commands to CPU 11A. In like fashion, mouse input device 18A is also used for operator input to CPU 11B. Any event change from Keyboard 17A, Mouse 18B or display data in RAM 13A causes an update to occur on the remote computer 10B and the Monitor 16B.

Optional printer 19 is used to create a hard copy of the material being displayed to the operator via Monitor 16.

The input devices for Computer 10B are the same as Computer 10A. Keyboard 17B and Mouse 18B are used to communicate operator commands to CPU 11B.

FIG. 1C is a graphical representation for the preferred memory organization for the computer illustrated in FIG. 1A.

Memory 9, located preferably in volatile memory 13A, contains the data that is displayed on Monitor 16A. It is in the form of pixel data, which contains an x and y coordinate.

Memory 10, located preferably in non-volatile memory 12A, contains data about the setup of Computer 10A and the software responsible for communicating the display data.

FIG. 1D graphically illustrates the connection of Computers 10A and 11B. A connection is initiated by Computer 11B through Network 20 to Computer 11A. Computer 11A is identified by the URL address of the computer. The operator enters in this URL address on Computer 11B and after initial handshaking authentications, the display on Monitor 16A is shown on Monitor 16B.

FIG. 1E is a flow-chart of the preferred embodiment's remote monitoring system.

After start 40A, a connection is made from the client computer to the server computer 40B over the distributed computer network using the URL associated with the server computer. The operator on the client computer enters the password 40C associated with the server computer. The server searches its memory to validate the password. If the password does not match, the client is disconnected 40F and the process is stopped 40G. If the password matches, the initialization continues.

The client is initialized 40H by the client by sending passed authentication message, followed by the version of the communications protocol used and whether the client will have exclusive access to the server or that it may be shared with other clients.

The server is initialized 40I, the width and height of the server's display memory, its pixel format and the server name are transmitted by the server.

The server then begins to communicate the display data that will be shown on the client monitor. These messages continue until the server or the client initiate a disconnect message 40K and the process is stopped 40L.

FIG. 1F illustrates the flow chart transmitted/receive event messages.

I claim:

1. A method of displaying data comprising:
a distributed computer network including providing a first computer having a first data storage medium and a first data display device;
providing a second computer having a second data storage medium and a second data display device;
coupling the first computer to the second computer via a communication link to form a distributed computer network;
displaying data on the first display device;
the second computer retrieving from the first storage medium via the communication link the data being displayed in said displaying step; and
displaying the data retrieved in said retrieving step on the second data display device in real time with the displaying of the same data on the first data display device.

2. The method of claim 1 further comprising the steps of:
receiving a retrieval request from the second computer by the first computer;
sending a password request from the first computer to the second computer;
receiving the password request from the first computer by the second computer;
responding to the password request with a password; and
authenticating the password.

3. The method according to claim 2 wherein all of the steps of claim 2 are performed prior to said retrieving step.

4. The method according to claim 2 wherein said step of receiving a retrieval request occurs prior to said step of sending a password request.

5. The method according to claim 2 wherein said step of receiving a retrieval request occurs after said step of sending a password request.

6. The method according to claim 1 wherein said retrieval request is a request for medical data.
